(19) United States
(12) Patent Application Publication
(10) Pub. No.: US 2013/0202308 A1
(43) Pub. Date: Aug. 8, 2013

(54) PHASED ANTENNA ARRAY INCLUDING A PLURALITY OF ELECTRO-OPTICAL CIRCUITS HAVING AN OPTICAL SOURCE WITH AN OPTO-ELECTRONIC OSCILLATOR AND ASSOCIATED METHODS

(71) Applicants: Charles Middleton, Rockledge, FL (US); Alan Mast, Melbourne Beach, FL (US); Jay Kralovec, Viera, FL (US); Richard Desalvo, Satellite Beach, FL (US); Gus W. Deibner, Melbourne, FL (US); Jeff Philo, Melbourne, FL (US)

(72) Inventors: Charles Middleton, Rockledge, FL (US); Alan Mast, Melbourne Beach, FL (US); Jay Kralovec, Viera, FL (US); Richard Desalvo, Satellite Beach, FL (US); Gus W. Deibner, Melbourne, FL (US); Jeff Philo, Melbourne, FL (US)

(73) Assignee: Harris Corporation, Corporation of the State of Delaware, Melbourne, FL (US)

(21) Appl. No.: 13/368,420

(22) Filed: Feb. 8, 2012

(51) Int. Cl. H04B 10/10; H01P 11/00

(52) U.S. Cl. 398/116; 29/601

(57) ABSTRACT

A phased antenna array includes a plurality of electro-optic (EO) circuits. Each EO circuit has a digital-to-analog converter (DAC) configured to receive a baseband signal, and an optical source comprising an opto-electronic oscillator configured to generate an optical signal. Each EO circuit also has an EO modulator coupled downstream of the DAC and to the optical source and configured to modulate an optical carrier signal based upon the baseband signal and the optical signal, and an optical combiner coupled downstream of the EO modulator and coupled to the optical source. In addition, there are a plurality of antenna circuits spaced apart from the plurality of EO circuits, each antenna circuit comprising at least one photodiode and an antenna element coupled thereto. Moreover, a plurality of optical fibers couple the plurality of EO circuits to the plurality of antenna circuits.

### FIELD OF THE INVENTION

The present invention relates to the field of phased antenna arrays, and, more particularly, to phased antenna arrays with optical components and related methods.

### BACKGROUND OF THE INVENTION

A typical wireless communications device includes an antenna, and a transceiver coupled to the antenna. The transceiver and the antenna cooperate to transmit and receive communications signals.

One particularly advantageous antenna type is the phased array antenna. The phased array antenna comprises a plurality of antenna elements, and processing circuitry to vary the related phase of the signals received from the individual antenna elements or sent to the antenna elements. The varying of the related phase of the antenna elements may provide for changing the effective radiation pattern of the antenna. In particular, the radiation pattern can be changed to be highly directional, i.e. reinforcing signals received from one direction and rejecting those received from other directions. Each directional pattern is commonly described as a beam, and the changing of the directional pattern is known as beam forming.

Beam forming operations may be performed either in the analog domain or in the digital domain. For example, in the analog approaches, the phased array antenna includes some form of time delay mechanism. In digital beam forming applications, the signal to the antenna element is converted into a digital signal, and digital signal processors perform the time delay operations.

As the operational frequency of the phased array antenna increases, the physical size of the individual antenna element becomes smaller. Moreover, the computational requirements for digital beam forming may become onerous. Indeed, as the space between antenna elements becomes constrained, the packaging size for processing components for each antenna element needs to be reduced. For example, millimeter wave, i.e. extremely high frequency (EHF), phased array antennas may be complex and costly to manufacture. Furthermore, these phased array antennas may be limited in bandwidth and the number of beams.

One approach to the phased array antenna is disclosed in U.S. Pat. No. 5,999,128 to Stephens et al. This phased array antenna includes a plurality of antenna elements, and a plurality of optical paths with varying lengths coupled to the respective antenna elements. The phased array antenna comprises a plurality of phase coherent sources, and a plurality of combiners coupled downstream for the phase coherent sources for providing a signal to the optical paths.

### SUMMARY OF THE INVENTION

In view of the foregoing background, it is therefore an object of the present invention to provide a phased antenna array that can operate effectively at high frequencies.

This and other objects, features, and advantages in accordance with the present invention are provided by a phased antenna array comprising a plurality of electro-optic (EO) circuits. Each EO circuit comprises a digital-to-analog converter (DAC) configured to receive a baseband signal, and an optical source comprising an opto-electronic oscillator (OEO) configured to generate an optical signal. Each EO circuit further comprises an EO modulator coupled downstream of the DAC and to the optical source and configured to modulate an optical carrier signal based upon the baseband signal and the optical signal, and an optical combiner coupled downstream of the EO modulator and coupled to the optical source.

A plurality of antenna circuits are spaced apart from the plurality of EO circuits, with each antenna circuit comprising at least one photodiode and an antenna element coupled thereto. In addition, a plurality of optical fibers couple the plurality of EO circuits to the plurality of antenna circuits. This phased antenna array advantageously converts the electrical signal from the DAC to the optical domain for more efficient processing. In addition, by spacing the antenna circuits apart from the EO circuits, the antenna circuits may be packed tightly together to thereby allow for good performance at high frequencies.

In some applications, the optical source comprises continuous wave (CW) laser coupled to said OEO. In addition, the optical source may further comprise an optical amplifier coupled between said CW laser and said OEO. Moreover, each of the plurality of antenna circuits may comprise a power amplifier coupled between the at least one photodiode and the antenna element.

Further, each of the plurality of EO circuits may include an electrical delay block coupled between the DAC and the EO modulator. Also, each of the plurality of EO circuits may comprise an optical delay block coupled between the EO modulator and the optical coupler

The plurality of antenna circuits may comprise at least one vertically polarized antenna circuit and/or at least one horizontally polarized antenna circuit.

A method aspect is directed to a method of making a phased antenna array. The method comprises forming a plurality of electro-optic (EO) circuits by, for each EO circuit, configuring a digital-to-analog converter (DAC) to receive a baseband signal, and configuring an optical source comprising an opto-electronic oscillator (OEO) to generate an optical signal. For each EO circuit, the method also includes coupling an EO modulator downstream of the DAC and to the optical source and configuring the EO modulator to modulate an optical carrier signal based upon the baseband signal and the optical signal, and coupling an optical combiner downstream of the EO modulator to the optical source. The method further includes spacing a plurality of antenna circuits apart from the plurality of EO circuits, each antenna circuit comprising at least one photodiode and an antenna element coupled thereto, and coupling the plurality of EO circuits to the plurality of antenna circuits using a plurality of optical fibers.

### BRIEF DESCRIPTION OF THE DRAWINGS

FIG. 1 is a schematic block diagram of a phased antenna array in accordance with the present invention.

FIG. 2 is a flowchart of a method of making the phased antenna array of FIG. 1.

FIG. 3 is a schematic block diagram of an additional embodiment of a phased antenna array in accordance with the present invention.

FIG. 4 is a flowchart of a method of making the phased antenna array of FIG. 3.

FIG. 5 is a schematic block diagram of a further embodiment of a phased antenna array in accordance with the present invention.

FIG. 6 is a flowchart of a method of making the phased antenna array of FIG. 5.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notation is used to indicate similar elements in alternative embodiments.

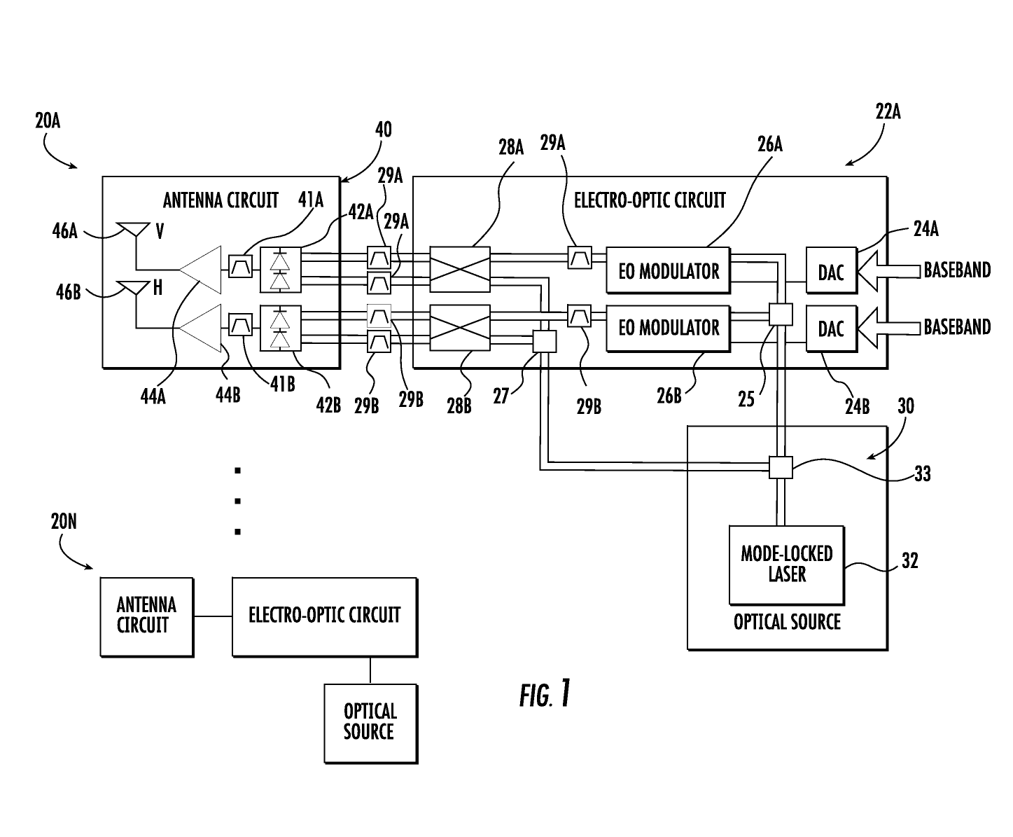

Referring initially to FIG. 1, a phased antenna array 20a . . . 20n is now described. For clarity, only the phased antenna 20a will be described, but it should be understood that there may be any number of such phased antennas. The phased antenna 20a includes a plurality of electro-optic (EO) circuits 22. Each EO circuit comprises a digital-to-analog converter (DAC) 24a, 24b configured to receive a baseband signal, and each DAC is, in turn, coupled to a respective EO modulator 26a, 26b. An optical source 30 is coupled to each EO modulator 26a, 26b and is configured to generate an optical signal. In particular, the optical source 30 comprises a mode-locked laser 32 which, via optical splitters 33, 25 is coupled to the EO modulators 26a, 26b.

As will be understood by those of skill in the art, a mode-locked laser 32 produces pulses of light rather than a continuous stream of light. The EO modulators 26a, 26b are configured to receive the analog signal from the DACs 24a, 24b, as well as the optical signal, and to modulate an optical signal at an intermediate frequency based thereupon. This optical carrier signal has a frequency spectrum including the intermediate frequency and a pair of sidebands.

Optical combiners 28a, 28b are coupled downstream of the EO modulators 26a, 26b to the optical source 30 via the optical splitters 33, 27. The optical combiners 28a, 28b upconvert the optical signal at the intermediate frequency to a desired carrier frequency, and deliver the resulting modulated optical carrier signals to the antenna circuits 40 via optical fibers.

Each antenna circuit 40 includes a pair of photodiodes 42a, 42b, which convert the optical carrier signal to an electrical carrier signal, and thereafter feed the electrical carrier signal to power amplifiers 44a, 44b. The power amplifiers 44a, 44b amplify the electrical carrier signal and feeds it to the respective antennas 46a, 46b, which then radiate the electrical carrier signals.

This phased antenna array 20a . . . 20n provides a variety of advantages. Since the baseband signals are promptly converted to the optical domain, the optical coupling between the SO circuits 22 and the antenna circuits 40 can be of significant length and without the typical losses of common electrical connections. Indeed, the antenna circuits 40 can be remote from the EO circuits 22. The antenna circuits 40 may be located several miles from the EO circuits 22, which is a configuration that would not be possible with the phase losses inherent in electrical-only systems. In addition, the physical separation between the EO circuits 22 and the antenna circuits 40 allows dense packing of multiple antenna elements together, thereby allowing the phased antenna array 20a . . . 20n to operate efficiently at high frequencies.

In some applications, a bandpass filtering of the intermediate optical signal or the optical carrier signal may be desired to remove unwanted frequencies. Therefore, optical bandpass filters 29a, 29b may be optionally coupled between the EO modulators 26a, 26b and the optical combiners 28a, 28b, or between the optical combiners and the photodiodes 42a, 42b. Alternatively, the bandpass filtering may be performed after the optical carrier signal is converted back to the electrical domain by electrical bandpass filters 41a, 41b coupled between the photodiodes 42a, 42b and the power amplifiers 44a, 44b.

As illustrated, the antennas 46a, 46b are polarized differently, with the antenna 46a being vertically polarized, and the antenna 46b being horizontally polarized. The use of two separate EO circuits 22 to feed these separate antennas 46a, 46b provides isolation for the horizontal and vertical polarizations.

Those skilled in the art will appreciate that the phased antenna array 20a . . . 20n may include any number of EO circuits 22 and antenna circuits 40. Indeed, in some applications, there may be a single EO circuit 22 and a single antenna circuit 40 which feed a single antenna 46a so as to produce an antenna system that is not a phased antenna array.

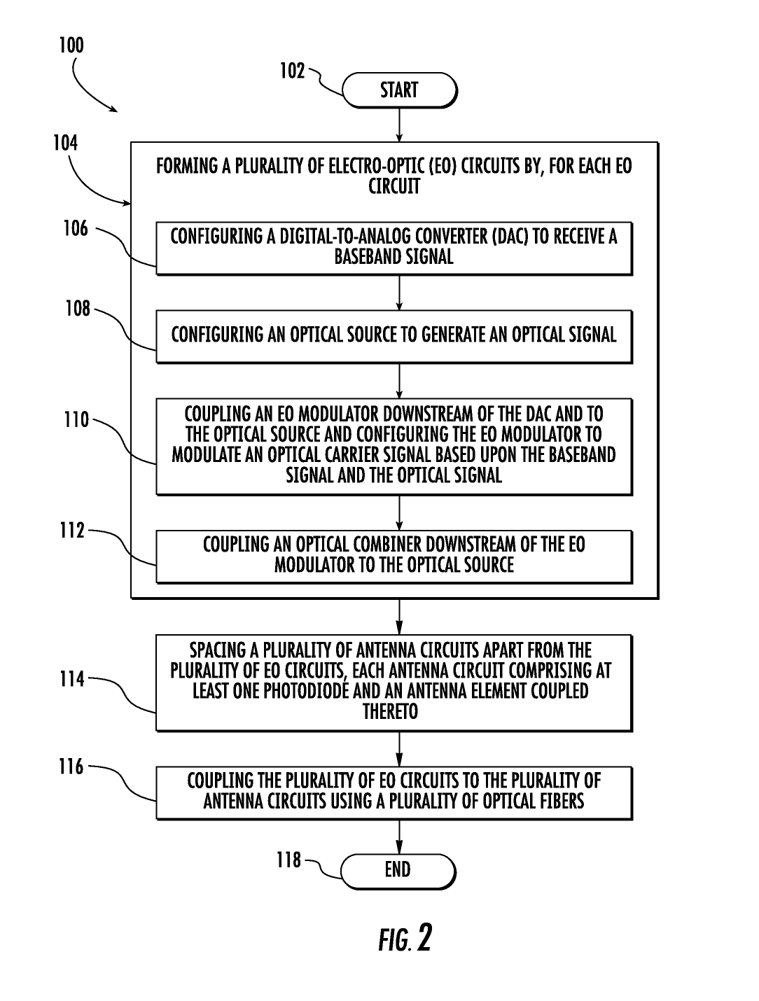

With reference to the flowchart 100 of FIG. 2, a method of making the phased antenna array described above is now described. After the start (Block 102), a plurality of EO circuits are formed (Block 104). Forming the plurality of EO circuits includes the following steps.

First, a DAC is configured to receive a baseband signal (Block 106). Then, an optical source is configured to generate an optical signal (Bock 108). Thereafter, an EO modulator is coupled downstream of the DAC and to the optical source, and the EO modulator is configured to modulate an optical carrier signal based upon the baseband signal and the optical signal (Block 110). Then, an optical combiner is coupled downstream of the EO modulator and to the optical source (Block 112).

Now that the EO circuits are formed and Block 104 is complete, a plurality of antenna circuits are spaced apart from the plurality of EO circuits, with each antenna circuit comprising at least one photodiode and an antenna element coupled thereto (Block 114). Then, the plurality of EO circuits is coupled to the plurality of antenna circuits using a plurality of optical fibers (Block 116). Block 118 indicates the end of the method.

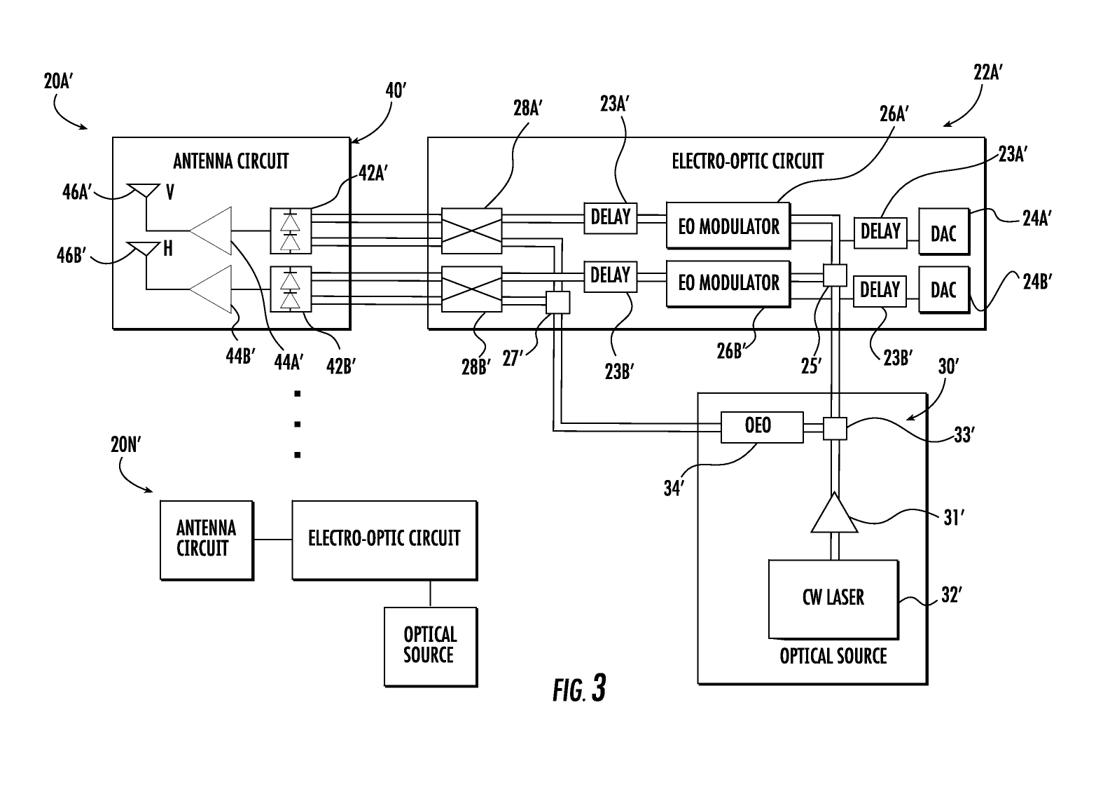

An alternate embodiment of the phased antenna array 20a′. . . 20n′ is now described with reference to FIG. 3. In this embodiment, the optical source 30′ contains different components. In particular, the optical source 30′ comprises a continuous-wave (CW) laser 32′ coupled to an optical amplifier 31′, which is in turn coupled to the EO modulators 26a′, 26b′ via optical splitters 33′, 25′. The CW laser 32′ is also coupled to an opto-electronic oscillator 34′, which is in turn coupled to the optical combiners 28a′, 28b′ via the optical splitter 27′.

Since the CW laser 32′ outputs a continuous beam of light, the OEO 34′ is used so as to provide an optical signal at the desired carrier frequency to the optical combiners 28a′, 28b′ such that the optical combiners may upconvert the intermediate optical signal provided by the EO modulators 26a′, 26b′ to the desired carrier frequency.

In addition, in this embodiment, it may be helpful to introduce a delay to the system. This delay may be introduced in the electronic domain before opto-electronic conversion by the optional delay blocks 23a′, 23b′, or in the optical domain before upconversion by the optional delay blocks 29a′ 29b′.

Those elements not specifically described above are similar to the components of the phased antenna array 20a . . . 20n of FIG. 1 and need no further discussion herein.

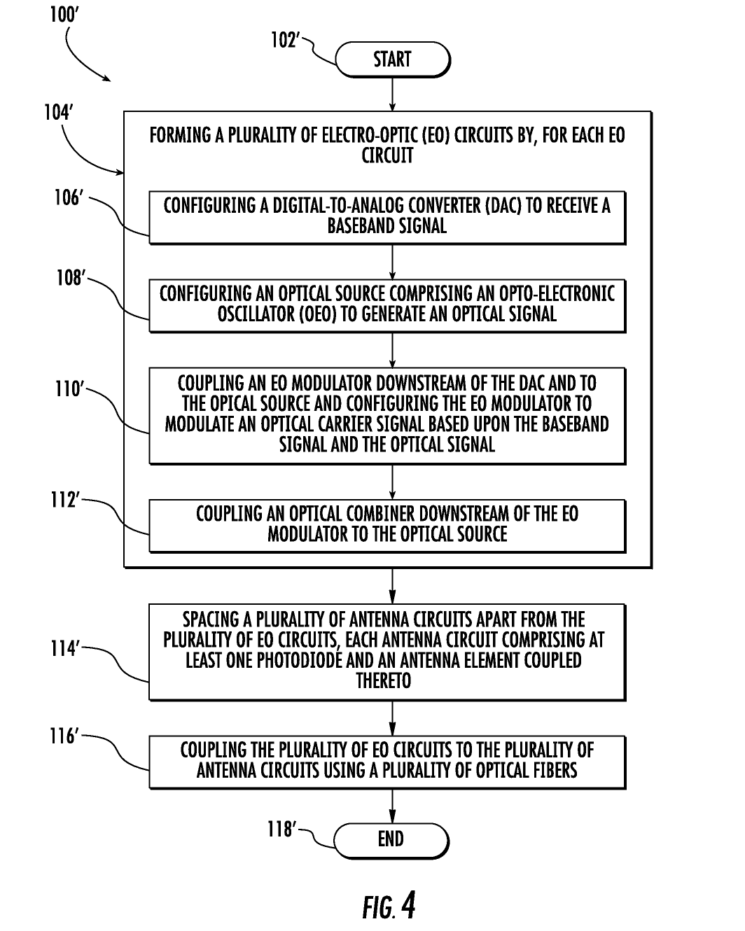

With reference to the flowchart 100′ of FIG. 4, a method of making the phased antenna array described above is now described. After the start (Block 102′), a plurality of EO circuits are formed (Block 104′). Forming the plurality of EO circuits includes the following steps.

First, a DAC is configured to receive a baseband signal (Block 106′). Then, an optical source comprising an OEO is configured to generate an optical signal (Bock 108′). Thereafter, an EO modulator is coupled downstream of the DAC and to the optical source, and the EO modulator is configured to modulate an optical carrier signal based upon the baseband signal and the optical signal (Block 110′). Then, an optical combiner is coupled downstream of the EO modulator and to the optical source (Block 112′).

Now that the EO circuits are formed and Block 104′ is complete, a plurality of antenna circuits are spaced apart from the plurality of EO circuits, with each antenna circuit comprising at least one photodiode and an antenna element coupled thereto (Block 114′). Then, the plurality of EO circuits is coupled to the plurality of antenna circuits using a plurality of optical fibers (Block 116′). Block 118′ indicates the end of the method.

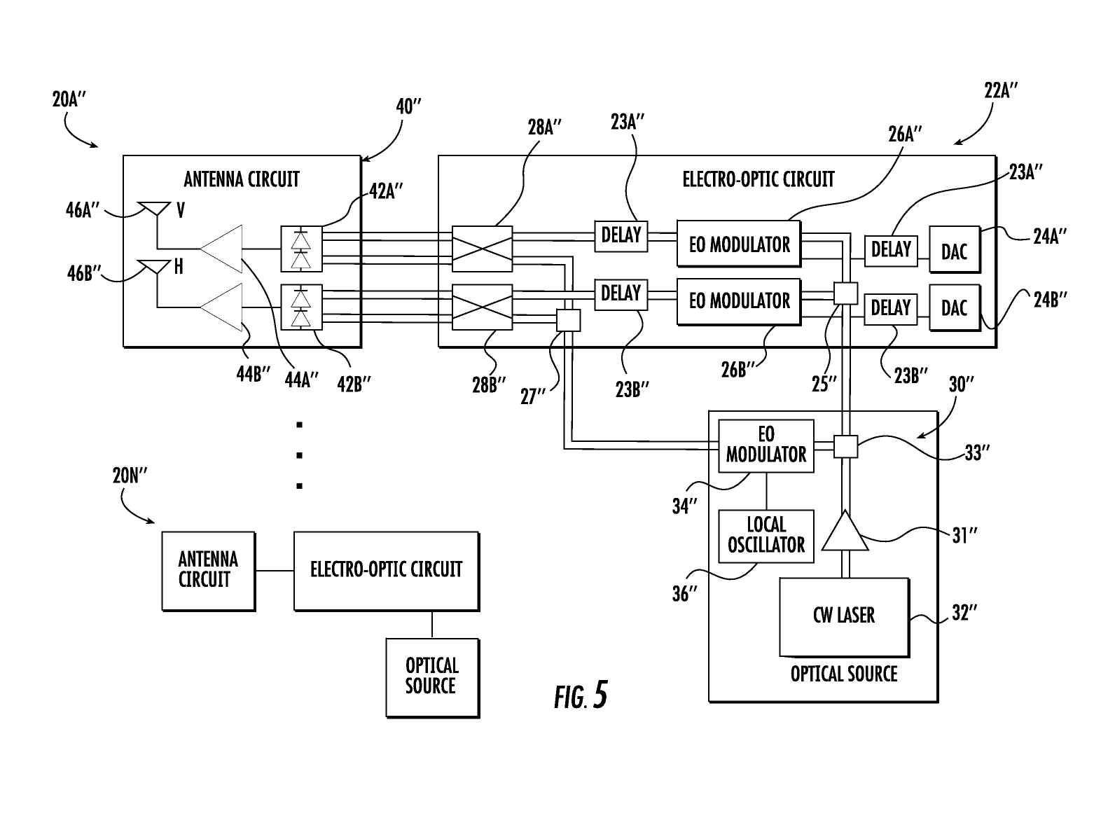

With reference to FIG. 5, a further embodiment of the phased antenna array 20a″. . . 20n″ is now described. Here, the optical source 30″ also contains different components. In particular, the optical source 30″ comprises a CW laser 32″ coupled to an optical amplifier 31″, which is in turn coupled to the EO modulators 26a″, 26b″ via the optical splitters 33″, 25″. The CW laser 32″ is also coupled to an optical source EO modulator 34″ via the optical splitter 33″. The optical source EO modulator 34″ is coupled to a local oscillator 36″ so that the optical source EO modulator can output an optical signal having the desired carrier frequency for the optical combiners 28a″, 28b″ to use to upconvert the intermediate optical frequencies from the EO modulators 26a″, 26b″ to the desired carrier frequency. The use of a local oscillator 36″ is advantageous because it allows great flexibility in terms of the ultimate carrier frequency.

Those elements not specifically described above are similar to the components of the phased antenna array 20a′. . . 20n′ of FIG. 3 and need no further discussion herein.

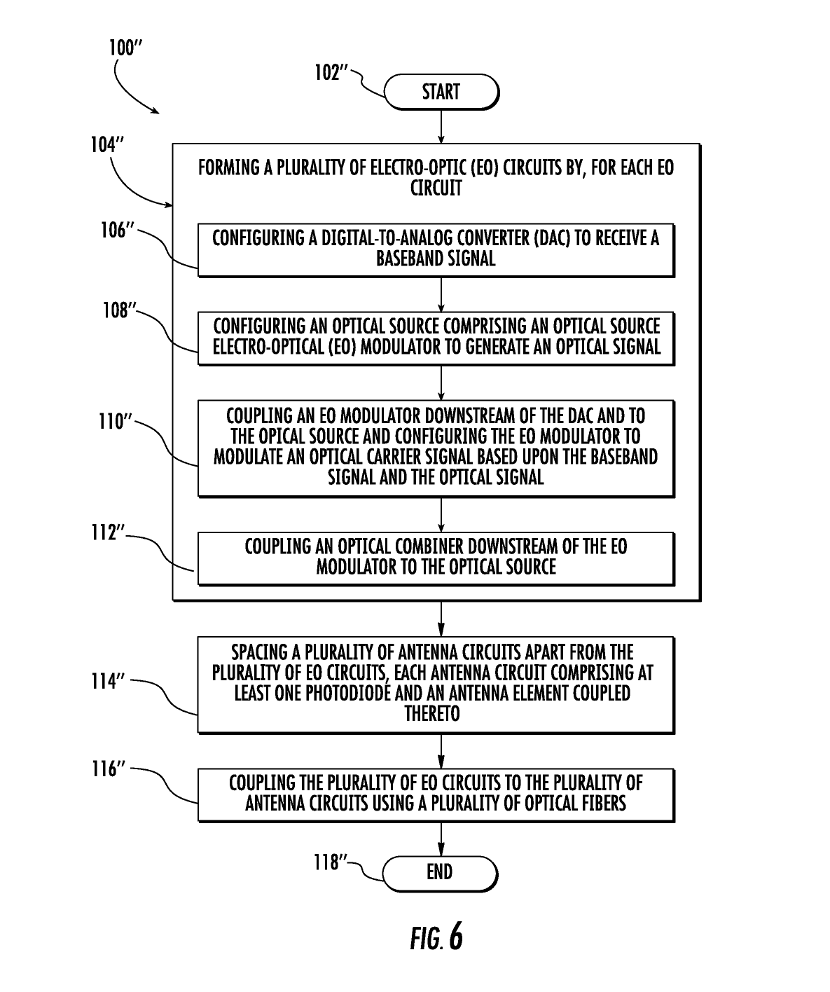

With reference to the flowchart 100″ of FIG. 6, a method of making the phased antenna array described above is now described. After the start (Block 102″), a plurality of EO circuits are formed (Block 104″). Forming the plurality of EO circuits includes the following steps.

First, a DAC is configured to receive a baseband signal (Block 106″). Then, an optical source comprising an EO modulator is configured to generate an optical signal (Bock 108″). Thereafter, an EO modulator is coupled downstream of the DAC and to the optical source, and the EO modulator is configured to modulate an optical carrier signal based upon the baseband signal and the optical signal (Block 110″). Then, an optical combiner is coupled downstream of the EU modulator and to the optical source (Block 112″).

Now that the EO circuits are formed and Block 104″ is complete, a plurality of antenna circuits are spaced apart from the plurality of EO circuits, with each antenna circuit comprising at least one photodiode and an antenna element coupled thereto (Block 114″). Then, the plurality of EU circuits is coupled to the plurality of antenna circuits using a plurality of optical fibers (Block 116″). Block 118″ indicates the end of the method.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A phased antenna array comprising:
a plurality of electro-optic (EO) circuits, each comprising
a digital-to-analog converter (DAC) configured to receive a baseband signal,
an optical source configured to generate an optical signal and comprising an opto-electronic oscillator (OEO);
an EO modulator coupled downstream of said DAC and to said optical source and configured to modulate an optical carrier signal based upon the baseband signal and the optical signal, and
an optical combiner coupled downstream of said EO modulator and coupled to said optical source;
a plurality of antenna circuits spaced apart from said plurality of EO circuits, each antenna circuit comprising at least one photodiode and an antenna element coupled thereto; and
a plurality of optical fibers coupling said plurality of EO circuits to said plurality of antenna circuits.

2. The phased antenna array of claim 1, wherein said optical source further comprises a continuous wave (CW) laser coupled to said OEO.

3. The phased antenna array of claim 1, wherein said optical source further comprises an optical amplifier coupled between said CW laser and said OEO.

4. The phased antenna array of claim 1, wherein each of said plurality of antenna circuits comprises a power amplifier coupled between said at least one photodiode and said antenna element.

5. The phased antenna array of claim 1, wherein each of said plurality of EO circuits comprises an optical delay block coupled between said EO modulator and said optical coupler.

6. The phased antenna array of claim 1, wherein each of said plurality of EO circuits comprises an electrical delay block coupled between said DAC and said EO modulator.

7. The phased antenna array of claim 1, wherein said plurality of antenna circuits comprises at least one vertically polarized antenna circuit.

8. The phased antenna array of claim 1, wherein said plurality of antenna circuits comprises at least one horizontally polarized antenna circuit.

9. An electronic device comprising:
an electro-optic (EO) circuit comprising
a digital-to-analog converter (DAC) configured to receive a baseband signal,
an optical source configured to generate an optical signal and comprising an opto-electronic oscillator (OEO);
an EO modulator coupled downstream of said DAC and to said optical source and configured to modulate an optical carrier signal based upon the baseband signal and the optical signal, and
an optical combiner coupled downstream of said EO modulator and coupled to said optical source;
an antenna circuit spaced apart from said EU circuit and comprising at least one photodiode and an antenna element coupled thereto; and
at least one optical fiber coupling said EO circuit to said antenna circuit.

10. The electronic device of claim 9, wherein said optical source further comprises a continuous wave (CW) laser coupled to said OEO.

11. The electronic device of claim 10, wherein said optical source further comprises an optical amplifier coupled between said CW laser and said OEO.

12. The electronic device of claim 9, wherein said antenna circuit comprises a power amplifier coupled between said at least one photodiode and said antenna element.

13. A method of making a phased antenna array comprising:
forming a plurality of electro-optic (EO) circuits by, for each EO circuit,
configuring a digital-to-analog converter (DAC) to receive a baseband signal,
configuring an optical source comprising an opto-electronic oscillator (OEO) to generate an optical signal,
coupling an EO modulator downstream of the DAC and to the optical source and configuring the EO modulator to modulate an optical carrier signal based upon the baseband signal and the optical signal, and
coupling an optical combiner downstream of the EO modulator to the optical source;
spacing a plurality of antenna circuits apart from the plurality of EO circuits, each antenna circuit comprising at least one photodiode and an antenna element coupled thereto; and
coupling the plurality of EO circuits to the plurality of antenna circuits using a plurality of optical fibers.

14. The method of claim 13, wherein configuring the optical source comprises configuring an optical course comprising an OEO and a continuous wave (CW) laser coupled thereto to generate an optical signal.

15. The method of claim 13, further comprising coupling a power amplifier between the at least one photodiode and the antenna element.

16. The method of claim 13, wherein forming a plurality of EO circuits further comprises coupling an optical delay block between the EO modulator and the optical coupler.

17. The method of claim 13, wherein forming a plurality of EO circuits further comprises coupling an electrical delay block between the DAC and the EO modulator.

18. The method of claim 13, further comprising configuring the plurality of antenna circuits such that the plurality of antenna circuits comprises at least one vertically polarized antenna circuit.

19. The method of claim 13, further comprising configuring the plurality of antenna circuits such that the plurality of antenna circuits comprises at least one horizontally polarized antenna circuit.
